(19) United States
(12) Patent Application Publication
(10) Pub. No.: US 2025/0202541 A1
(43) Pub. Date: Jun. 19, 2025

(54) EXTENSIBLE CUSTOMER PREMISE EQUIPMENT WITH REPEATER FUNCTION

(71) Applicant: Nokia Solutions and Networks Oy, Espoo (FI)

(72) Inventors: Jun GAO, Shanghai (CN); Cheng An ZHANG, Shanghai (CN); Qi TIAN, Shanghai (CN); Lei HUANGFU, Shanghai (CN)

(73) Assignee: Nokia Solutions and Networks Oy, Espoo (FI)

(21) Appl. No.: 18/980,345

(22) Filed: Dec. 13, 2024

(30) Foreign Application Priority Data
Dec. 14, 2023 (CN) 202311729595.X

(51) Int. Cl. H04B 7/0404; H04B 7/155

(52) U.S. Cl. CPC H04B 7/0404; H04B 7/155

(57) ABSTRACT

The embodiments of the present disclosure relate to a communication device, and specifically, to Customer Premise Equipment (CPE) with repeater function. The communication device includes: a donor antenna module for transmitting/receiving a radio frequency signal to/from a base station; a service antenna module for transmitting/receiving a radio frequency signal to/from a terminal; a System on Chip (SoC); an intermediate frequency transceiver coupled to the SoC; and a combiner comprising a combining port, a first branching port, and a second branching port, wherein the combing port is coupled to the donor antenna module via an intermediate frequency combining channel, the first branching port is coupled to the intermediate frequency transceiver via a first intermediate frequency branching channel, and the second branching port is coupled to the service antenna module via a second intermediate frequency branching channel.

### FIELD

Embodiments of the present disclosure generally relate to the field of communications technology, and more specifically, to an extensible Customer Premise Equipment (CPE) with repeater function.

### BACKGROUND

Customer Premise Equipment (CPE) is a device that can receive cellular signals (e.g. 4G, 5G, or the like) from a base station of an operator and convert them into Wireless Fidelity (Wi-Fi) or wired signals, to enable local devices to access networks. The CPE is not only used to convert mobile communication signals, but can also be used to enhance the coverage of the Wi-Fi signals, which has a wide application in 5G scenarios.

5G millimeter wave technology (mmW) is an important fundamental technology in 5G applications. The millimeter wave refers to a special electromagnetic wave with a wavelength from 1 to 10 millimeters and a frequency from 300 GHz to 300 GHz. As compared with the frequency band below 6 GHz, the millimeter wave has unique advantages such as greater bandwidth, lower air interface delay, more flexible air interface configuration, and the like. However, it has more serious attenuation characteristics. Therefore, how to expand the coverage of millimeter wave communication using a CPE needs to be further studied.

### SUMMARY

In general, example embodiments of the present disclosure relate to a communication device, comprising: a donor antenna module for transmitting/receiving a radio frequency signal to/from a base station; a service antenna module for transmitting/receiving a radio frequency signal to/from a terminal; a System on Chip (SoC); an intermediate frequency transceiver coupled to the SoC; and a combiner comprising a combining port, a first branching port, and a second branching port, wherein the combing port is coupled to the donor antenna module via an intermediate frequency combining channel, the first branching port is coupled to the intermediate frequency transceiver via a first intermediate frequency branching channel, and the second branching port is coupled to the service antenna module via a second intermediate frequency branching channel. In this way, an extensible CPE with repeater function can be achieved, effectively expanding the coverage range of mobile communications at a lower cost.

It would be appreciated that this Summary is not intended to identify key features or essential features of the present disclosure, nor is it intended to be used to limit the scope of the present disclosure. Other features of the present disclosure would be made more apparent through the following description.

### BRIEF DESCRIPTION OF THE DRAWINGS

FIG. 1 illustrates a schematic diagram of an example Fixed Wireless Access (FWA) environment.

FIG. 2 illustrates a schematic diagram of a communication device and signal flows thereof according to some embodiments of the present disclosure.

FIG. 3 illustrates a schematic diagram of a structure of a communication device according to some embodiments of the present disclosure.

FIG. 4 illustrates a schematic diagram of Operation, Administration, and Maintenance (OAM) management of an extensible CPE with repeater function according to some embodiments of the present disclosure.

FIG. 5A illustrates a schematic diagram of uplink communication of a communication device according to some embodiments of the present disclosure.

FIG. 5B illustrates a schematic diagram of downlink communication of a communication device according to some embodiments of the present disclosure.

FIG. 5C illustrates a timing diagram of a communication device of a communication device according to some embodiments of the present disclosure.

FIG. 6 illustrates a schematic flowchart of a scheduling process of a communication device according to some embodiments of the present disclosure.

Throughout the drawings, the same or similar reference symbols refer to the same or similar components.

### DETAILED DESCRIPTION OF EMBODIMENTS

Reference below will be made to some example embodiments illustrated in the drawings to describe the principles and spirits of the present disclosure. It would be appreciated that description of those specific embodiments is provided merely to enable those skilled in the art to better understand and implement the present disclosure and is not intended for limiting the scope disclosed herein in any manner.

As described herein, the term “include” or similar expressions are to be read as open-ended terms that mean “include, but not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

As used herein, the term “determine” encompasses a wide variety of actions. For example, “determining” can include calculating, computing, processing, deriving, investigating, looking up (e.g. looking up in a table, a database or another data structure), ascertaining and the like. Moreover, “determining” may include receiving (e.g., receiving information), accessing (e.g. accessing data in a memory) and the like. Further, “determining” may include resolving, selecting, choosing, establishing, and the like. For “at least one of the following: <a list of two or more elements>,” “at least one of <a list of two or more elements>,” and the like, as used herein, two or more elements in the list connected by “and” or “or” indicates at least one from those elements, or at least any two or more elements from those elements, or at least all the elements.

The term “circuitry” used herein may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s), software, and memory(ies) that work together to cause a device, such as a mobile phone or server, to perform various functions); and (c) hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, the term “circuitry” also covers an implementation of merely a hardware circuit or processor (or multiple processors) or portion of a hardware circuit or processor and its (or their) accompanying software and/or firmware. The term “circuitry” also covers, for example, if applicable to the particular claim element, a baseband integrated circuit, a processor integrated circuit, or a similar integrated circuit in an accessing point or other computing device.

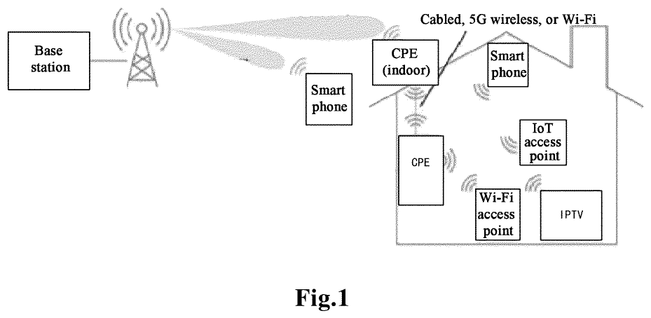

The CPE is widely used for home broadband, especially in situations that the Fiber to the Home (FTTH) cannot be installed. According to the Shannon Theorem, C=W*log2(1+S/N), where Cis signal capacity, W is spectrum width, and S/N is signal-to-noise ratio. Since the millimeter wave (mmW) has abundant resources, the throughput can reach about 10 Gbps. MmW CPE can be used in FWA scenarios due to the serious channel attenuation of the millimeter wave, as shown in FIG. 1.

Analog Beamforming (ABF) is a method of using the Radio Frequency (RF) signal processing technology to control amplitudes and phases of respective antenna elements in an antenna array, in order to achieve beamforming, where feed signals of each antenna element are combined at the RF carrier frequency level. In the process of implementing ABF, individual signals are first phase-shifted, amplified and directed to a desired transmitter using an analog phase shifter and an amplifier, and are then fed to each antenna element in the antenna array. The amplitude/phase change is applied to the analog signal at a receiving end, and the receiving end sums up the signals from different antennas and then performs analog-to-digital conversion.

In some implementations, a common baseband is used to reduce power consumption and complexity, and the beamforming is switched by beam pair training both in transmit (TX) and a receiver (RX) directions with a predefined codebook. The advantage of the ABF includes a higher antenna gain brought by a narrower beam band. In addition, a repeater with ABF function has an enhanced anti-interference capability.

To efficiently amplify and forward signals from a base station (BS) using control information from the network (e.g., when the BS side has a better Signal-to-Interference-plus-Noise Ratio (SINR)), a smart repeater may be used to obtain time-domain and space-domain information of an air-interface link for a millimeter coverage improvement. However, signaling the control information for each time slot may impose a significant burden on the control signaling overhead. Robustness design needs a strong baseband (BB) processor, which makes the system design more complicated and incurs a product cost higher than that of the typical RF pass-through repeater. Furthermore, the health status of the smart repeater should be monitored so that OAM messages can be communicated between the repeater and the network center. As a result, such complicated design will make the smart repeater less competitive in terms of the coverage improvement of the millimeter BS.

In view of the above, the embodiments of the present disclosure provide a communication device, where the repeater function is integrated in the communication device such as a Customer Premise Equipment (CPE), i.e., the communication device is expanded with the repeater function, to achieve the advantageous effect of expanding the base station coverage at a low cost. It would be appreciated that, although the millimeter wave is taken an example herein to describe the embodiments of the present disclosure, the technical solution of the present disclosure is not limited to millimeter-wave communication. Furthermore, although a CPE with expanded repeater function is described as an example, the technical solution of the present disclosure can be applied to any appropriate communication device, rather than limited to an extensible CPE.

According to some embodiments of the present disclosure, an Mmw Antenna Module (MAM) of the CPE can be shared as a Donor Unit (DU) of a repeater, thereby reducing the cost. For clarity, an MAM in the DU in this disclosure may be referred to as a Master-MAM (M-MAM) or a donor antenna module, and an MAM in a Service Unit (SU) of the repeater may be referred to as a Slave-MAM (S-MAM) or a service antenna module. The M-MAM in the donor unit is used for transmitting/receiving radio frequency signals to/from a base station, and the S-MAM in the service unit is used for transmitting/receiving radio frequency signals to/from a terminal. As described herein, the M-MAM, the DU, and the donor antenna module can be used interchangeably, while the S-MJAM, the SU, and the service antenna module can be used interchangeably.

In some embodiments, control circuits (at the logic and software sides) of the CPE can be shared for the repeater to make the implementation simple and efficient. In some embodiments, an Intermediate Frequency (IF) and digital receiver path of the CPE can be shared for beamforming estimation of the service antenna module of the repeater, thereby reducing the cost. In some embodiments, a CPE Wide Access Network (WAN) Management Protocol (CWMP) stack of the CPE can be reused for the network management of the repeater. In this case, different hardware identifiers (HW IDs) may be used to differentiate the CPE and the repeater from each other.

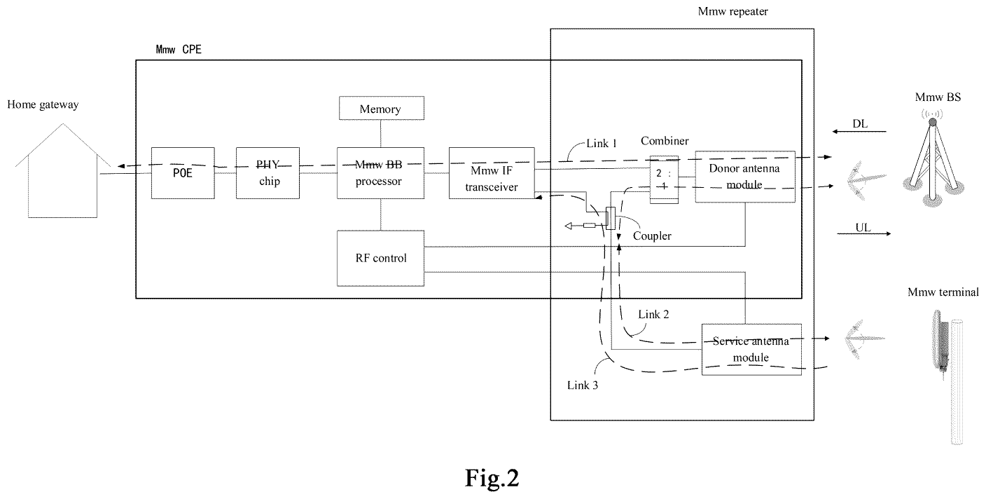

The legacy solution includes an independent Mmw CPE and an independent Mmw repeater. The present disclosure provides a joint solution which is implemented not only at the hardware side but also in the control and software side (e.g. switching, beam controlling, OAM, and the like). The embodiments of the present disclosure will be described in detail with reference to FIGS. 2-6.

FIG. 2 illustrates a schematic diagram of a communication device and signal flows thereof according to some embodiments of the present disclosure. The communication device shown in FIG. 2 is provided only exemplarily, where some components or parts may be omitted without departing from the scope of the solution of the present disclosure.

As shown therein, the communication device may be connected to a home network wirelessly or via cable, and it may include components associated with the Mmw CPE and components associated with the Mmw repeater. The components associated with the Mmw CPE may include a Power on Ethernet (POE), a physical layer chip, an Mmw baseband processor (e.g., in a System on Chip (SoC)), an Mmw intermediate frequency transceiver, a memory, an RF controller, and the like. The components associated with the Mmw repeater may include a donor antenna module, a service antenna module, a combiner and a coupler.

In the communication device, the link 1 between the home gateway and the Mmw base station includes the donor antenna module, the combiner, the Mmw intermediate frequency transceiver, the Mmw baseband processor, and the like, which is a typical CPE communication link. The link 2 between the Mmw terminal and the Mmw base station includes the donor antenna module, the combiner, the coupler, and the service antenna module, for use in signal forwarding, which is a typical repeater communication link.

The link 1 and the link 2 are combined at the combiner, and have a shared donor antenna module. The combiner includes a combining port, a first branching port, and second branching port. The combining port is coupled to the donor antenna module via an intermediate combining channel, the first branching port is coupled to the intermediate frequency transceiver via a first intermediate frequency branching channel, and the second branching port is coupled to the service antenna module via a second intermediate frequency branching channel (via the coupler).

In some embodiments, the communication device can be configured to operate in a Time Division Duplex (TDD) mode. Correspondingly, the donor antenna module and the service antenna module each include a radio frequency switch for the TDD mode, to switch the antenna array between transmitting and receiving. It is worth noting that, within a downlink period of the TDD mode, a first downlink signal from the first branching port to the intermediate frequency transceiver is identical to a second downlink signal from the second branching port to the service antenna module, but different hardware identifiers (HW IDs) are used to differentiate signals of the CPE and the repeater. In some embodiments, the donor antenna module may have a hardware identifier for the CPE, and the service antenna module may have a hardware identifier for the repeater.

In some embodiments, uplink transmission of the Mmw intermediate frequency transceiver of the CPE (via the link 1) and uplink transmission of the service antenna module (via the link 2) can be combined using a passive combiner. Due to isolation of a link switch of a TDD configuration and port isolation of the passive combiner, there would be no obvious interference generated between the uplink transmission of the Mmw intermediate frequency transceiver of the CPE and the uplink transmission of the service antenna module. For downlink receiving, signals received by the donor antenna module from the base station can be divided into 2 ways; one is routed to the downlink receiving of the Mmw intermediate frequency transceiver, for baseband processing, and the other is routed to the service antenna module, to be forwarded by the repeater to the Mmw terminal.

The link 3 between the Mmw terminal and the Mmw baseband processor includes the Mmw intermediate frequency transceiver, the coupler, and the service antenna module, where the coupler is used to extract a coupled signal from the uplink signal of the service antenna module and provide the signal to the Mmw baseband processor for beamforming estimation in a remote Mmw terminal.

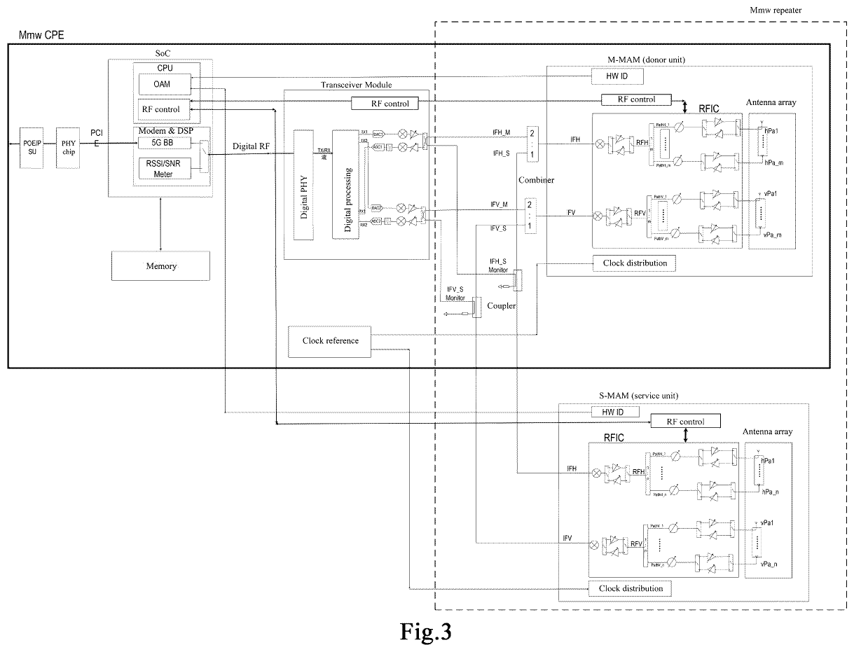

FIG. 3 illustrates a schematic diagram of a structure of a communication device according to some embodiments of the present disclosure. The structure shown in FIG. 3 is provided only exemplarily, where some components or parts may be omitted without departing from the scope of the solution of the present disclosure.

As shown therein, the Slave Mmw Antenna Module (M-MAM) includes a hardware identifier (HW ID) circuit, a clock distribution circuit, a Radio Frequency Integrated Circuit (RFIC), and an antenna array. The RFIC is used to perform frequency conversion between the Intermediate Frequency (IF) signal and the RF signal, and beamforming with different weights of amplitude and phase from Path 1 to Path m per polarization. The RFIC may work in the TDD mode via the RF switch, thereby implementing switching between uplink and downlink communication. In some implementations, the HW ID circuit may be formed with pull-up resistors with different values. The antenna array may include m elements per polarization.

The transceiver module is used for frequency conversion, digital processing (e.g. digital gain, digital filter, and the like). In some implementations, the transceivers module may be a Zero Intermediate Frequency (Zero IF) transceiver.

The Mmw repeater link is comprised of an M-MAM (a donor unit) and an S-MAM (a service unit). By means of the passive combiner, the repeater and the CPE can share the M-MAM. Therefore, when signal processing occurs on the CPE link, signal forwarding can also be completed between the M-MAM and the S-MAM. For example, the signal is forwarded to the M-MAM (i.e., to the base station) and to the S-MAM (i.e., to the Mmw terminal).

Basically, the service unit may be considered as a further hardware unit outside of the Mmw CPE due to different beam direction requirements for the M-MAM and the S-MAM. The interfaces between the donor unit and the service unit include IF interfaces (in horizontal and vertical directions), a clock reference from the CPE, and RF control signals.

In order to implement beam direction estimation for the S-MAM, IFH_S and IFV_S signals are detected by couplers (e.g., direction couplers). Receiver (RX) paths are shared by two types of switches. A first switch is a Double Pole Double Throw (DPDT) switch implemented in hardware, which is positioned in the intermediate frequency transceiver module and between the IFH_S/IFH_S monitoring signal and the RX ADC. Using the first switch, the intermediate frequency transceiver can be switched to the link (the link 3 in FIG. 2) to which the service antenna module is connected, to receive the monitoring signal (using the coupler). In some embodiments, the service antenna module is configured to transmit a reference signal for beamforming estimation in special time slot(s) of the TDD mode, and receive the measurement signal from the terminal in the special time slot(s). By means of the first switch and the coupler, the service antenna module can transmit measurement signals to the intermediate frequency transceiver module, and the measurement signals can be further transmitted to the SoC for beam estimation.

A second switch may be a Single Pole Double Throw (SPDT) switch implemented in logic, which is positioned in the SoC and used for switching between the baseband processing module and the beam management module. In some implementations, the baseband processing module may be a 5G baseband processor, which is used for modulation and demodulation on the UE side, and encoding and decoding of the 5G protocol stack. In some implementations, the beam management module may be a Received Signal Strength Indicator/Signal Noise Ratio (RSSI/SNR) meter for RF signal processing.

In some embodiments, the device may further include a motor for controlling rotation of the service antenna module, thereby providing a wider coverage in azimuth.

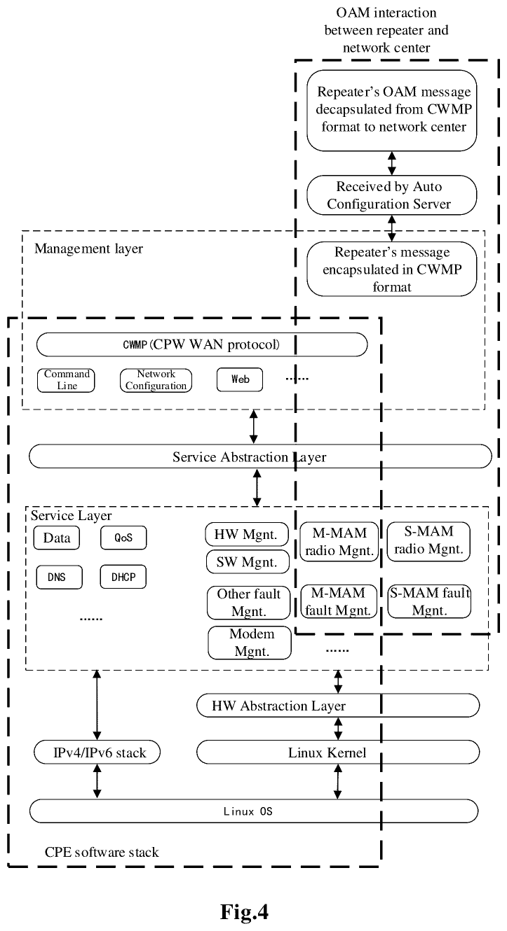

FIG. 4 illustrates a schematic diagram of Operation, Administration, and Maintenance (OAM) management of an extensible CPE with repeater function according to some embodiments of the present disclosure.

Device control (e.g. TDD control, beam control, or gain control) for the service antenna module can be implemented by Radio Frequency Control (RFC) software of the CPE, while OAM information of the service antenna module can also be reported to the network by an RFC bus (e.g. a Mobile Industry Processor Interface (MIPI)) via the CPE. As shown, the OAM message of the repeater can be encapsulated in a CPE Wide Access Network (WAN) Management Protocol (CWMP) format for better communication between the CPE/repeater and an Auto Configuration Server (ACS)/network center. Referring back to FIG. 3, the SoC may include an OAM management module which can be configured to transmit and receive OAM messages for the CPE and the repeater. In some embodiments, using the OAM management module, the SoC can be configured to encapsulate the OAM message of the repeater in the CWMP format, and transmit the OAM message in the CWMP format to the ACS, for decapsulation at the ACS and transmission to the network center. The OAM message of the repeater may include radio management (e.g. frequency/beam/gain control), fault management (e.g. a fault of a Power Amplifier (PA), a Low-Noise Amplifier (LNA), or a phase-locked loop), and the like.

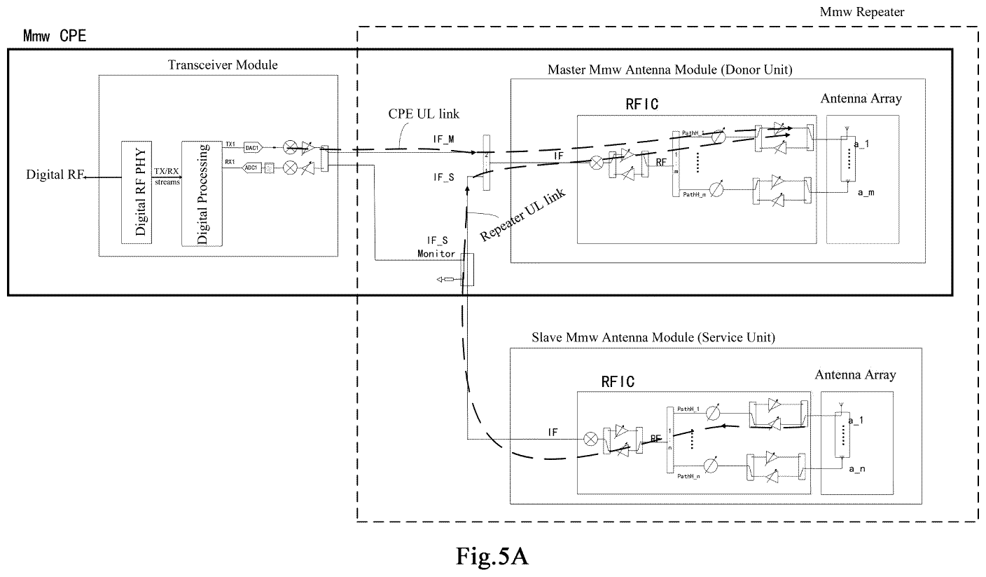

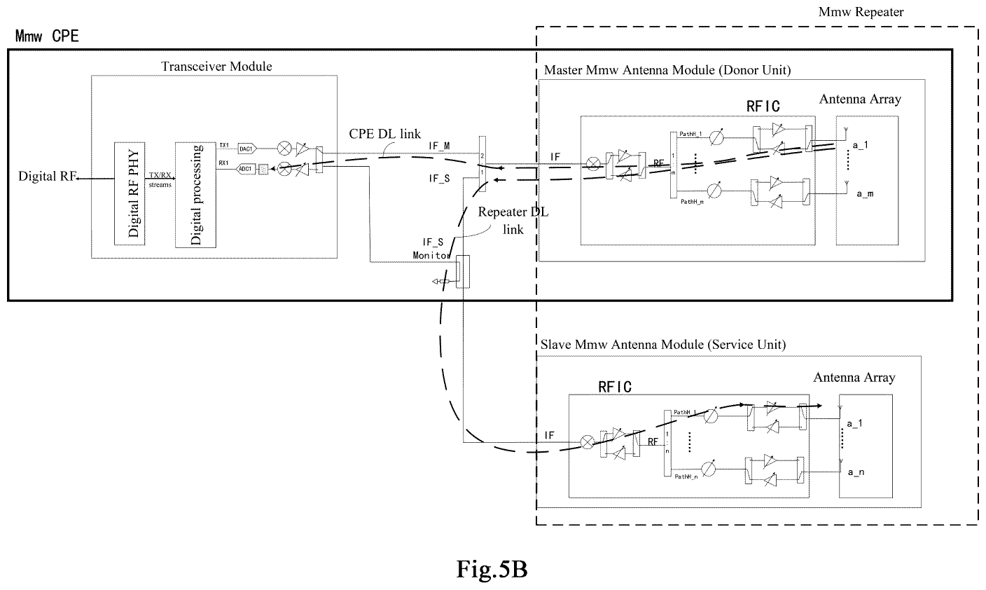

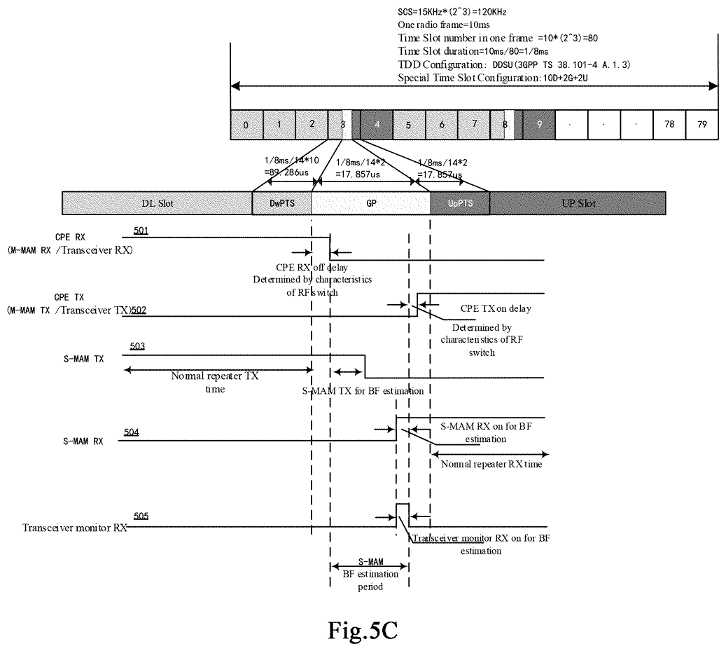

Since the signal of the CPE and the signal of the repeater are substantially different, the interference between them should be considered. Then, radio frequency control of the service antenna module will be described with reference to FIGS. 5A to 5C, where FIGS. 5A and 5B illustrate schematic diagrams of uplink and downlink communication of the communication device, respectively, and FIG. 5C illustrates an example timing diagram of the communication device.

Consider the leakage from the Intermediate Frequency Transmitting (IF TX) of the transceiver module or the CPE to the IF TX of the service antenna module (S-MAM). When the CPE operates in the uplink mode (i.e., the IF TX of the transceiver), the donor antenna module (M-MAM) operates in the uplink Transmitting (UL TX), and the service antenna module (S-MAM) operates in the uplink Receiving (UL RX). Since the RF switches of the service antenna module (S-MAM) operate in a receiving state, the IF TX of the CPE does not interfere with the IF transmitting of the service antenna module (S-MAM), as shown in FIGS. 5A and 5C.

Consider the leakage from the Intermediate Frequency Receiving (IF RX) of the service antenna module (S-MAM) to the Intermediate Frequency Receiving (IF RX) of the transceiver or the CPE When the CPE operates in the uplink mode (i.e., the transceiver is in the IF TX), the donor antenna module (M-MAM) operates in the uplink Transmitting (UL TX), and the service antenna module (S-MAM) operates in the uplink Receiving (UL RX). Since the intermediate frequency device (IF RF) switches of the transceiver operate in the Transmitting (TX), the IF RX of the service antenna module (S-MAM) does not interfere with the IF RX of the transceiver or the CPE, as shown in FIGS. 5B and 5C. In addition, in FIG. 5B, the CPE IF DL signal is identical to the repeater IF DL signal. Moreover, the CPE IF DL signal can be fed to the transceiver for down-conversion and baseband processing, and the repeater IF DL signal is only forwarded to the S-MAM for enhancement.

In general, although not required for Fixed Wireless Access (FWA), the runtime Beamforming (BF) can be used as a backup for some special cases (for example, the FWA terminal may be changed in azimuth). FIG. 5C illustrates an embodiment of a BF estimation period in a guard period. As shown therein, the 0^{th}, 1^{st}, 2^{nd}, 5^{th}, 6^{th}, and 7^{th} time slots are regular downlink time slots, the 3^{rd}, and 8^{th} time slots are special time slots, and the 4^{th}, and 9^{th} time slots are uplink time slots, where a high level indicates “enabled”, and a low level indicates “disenabled”.

FIG. 5C illustrates the timing 501 of the CPE RX (M-MAM RX/transceiver RX), the timing 502 of the CPE TX (M-MAM TX/transceiver TX), the timing 503 of the service antenna module TX (S-MAM TX), the timing 504 of the service antenna module RX (S-MAM RX), and the timing 505 of the transceiver monitor RX. In some embodiments, within the special time slot, transmitting of the donor antenna module (i.e., CPE/M-MAM TX) occurs after the transmitting of the service antenna module (S-MAM) has ended, and receiving of the service antenna module (i.e., S-MAM RX) occurs after the receiving of the donor antenna module (i.e., M-MAM RX) has ended. According to the timing 501 and 504, CPE/M-MAM RX is completed before the service antenna module RX, and the leakage of the service antenna module (S-MAM) RX therefore does not interfere with the CPE RX. According to the timing 502 and 503, S-MAM TX has been closed before CPE/M-MAM RX is started, and the leakage of CPE/M-MAM TX therefore does not interfere with S-MAM TX. In addition, according to the timing 503, 504 and 505, within the Guard Period (GP), S-MAM TX 503 is performed to transmit a reference signal, and S-MAM RX 404 and monitor RX 405 are then performed (via the coupler, and the DPDT switch) to receive a measurement signal from the terminal. The measurement signal can be transmitted to a module for beam management in the SoC via the SPDT switch, for use in beam estimation of the S-MAM. Moreover, in some implementations, auto gain control (AGC) for the S-MAM and the M-MAM may be similar, which is controlled via RFC signals.

According to some embodiments of the present disclosure, carrier configurations (e.g. frequency, bandwidth, and an output power) of the CPE and the repeater can be controlled by the base station. Here, the SoC of the CPE can be used as a network controller to configure frequency, bandwidth, and uplink output power for the CPE, and configure gain control, downlink output power, and the like for the repeater. It is to be noted that the uplink output power of the repeater should be synchronized and consistent with the uplink output power of the CPE.

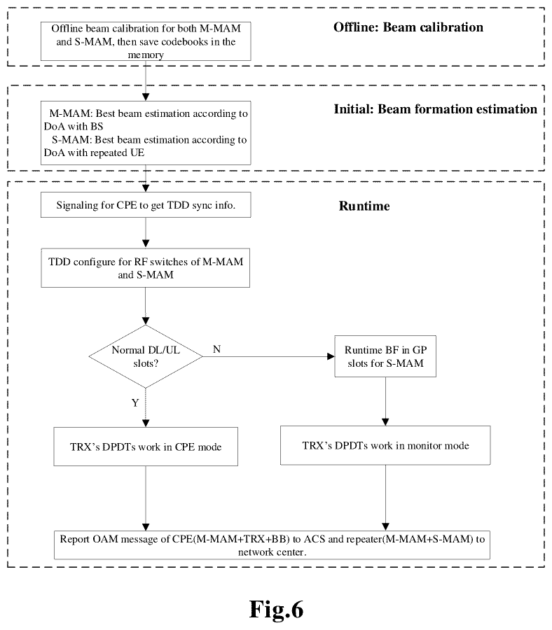

FIG. 6 illustrates an example flowchart of a scheduling process of the communication device according to some embodiments of the present disclosure. The scheduling process typically includes an offline phase for beam calibration, an initialization phase for beam estimation, and a runtime phase.

In the offline phase, offline beam calibration of the donor antenna module (M-MAM) and the service antenna module (S-MAM) is performed, and calibration results are then saved in the codebook. In the initialization phase, for the M-MAM, the optimal beam estimation is performed based on a Direction of Arrival (DoA) of the base station, and for the S-MAM, the optimal beam estimation is performed based on a Direction of Arrival (DoA) of the UE (e.g. Mmw terminal).

In the runtime phase, TDD synchronization information is extracted based on CPE signaling, and RF switches of the M-MAM and the S-MAM are then configured based on the TDD. When the device is operating, whether the current time slot is a normal uplink or downlink time slot is determined. If normal, the DPDT switch of the transceiver module operates in the CPE mode. If not, it is further determined whether runtime beamforming in the guard slot for the S-MAM is performed. If performed, the DPDT switch of the transceiver module operates in the monitor mode. At this time, the transceiver may forward to the SoC the monitor signal extracted from the coupler. As described above, if the SoC includes a separate beam management module, the SPDT switch of the SoC implemented in logic can be switched to the beam management module, for use in beam estimation. Then, during the operation of the device, the device can report the OAM messages of the CPE and the repeater to the network center, where the CPE at least includes a SoC, a transceiver module, and an M-MAM, and the repeater includes an M-MAM and an S-MAM.

Example embodiments of the present disclosure has been described above with reference to FIGS. 1-6. As compared with the existing solution, the embodiments of the present disclosure reuse the Mmw antenna module of the CPE as the donor antenna module of the repeater, and reuse the intermediate frequency receiving link of the CPE as the receiving link of the monitor signal of the repeater service antenna module, and in some embodiments, the SoC of the CPU may perform radio frequency control for the repeater. Therefore, the technical solution according to the present disclosure has a lower cost than the existing solution. Moreover, the control mechanism according to the technical solution of the present disclosure has a higher efficiency since the 3GPP protocol stack can be used to analyze the CPE link, making it easier to analyze and control the link of the repeater. Further, the CPE, as a home gateway device, has a fluent OAM capability, which can be shared for the repeater, to attain a more efficient, more intelligent repeater. Analysis and discussion on feasibility of the technical solution of the present disclosure will be provided below.

Deployment feasibility is first analyzed. A CPE is a type of user equipment. However, it is in the operator level and needs to be managed by a network center/ACS. A repeater is a network node, which also needs to be managed by the network center. The operator-level CPE and the network-node repeater can be uniformly deployed by the FWA operator.

Analysis is then made on product performance/certification feasibility. Compliant possibility between the CPE and the repeater is taken into consideration, as shown below in Table 1, where the repeater has three parameters stricter than those of the CPE, namely: transient period length, frequency error, and Adjacent Channel Leakage Ratio (ACLR).

TABLE 1
Performance requirement between CPE and repeater

| | CPE(UE) NR FR2 | Repeater NR FR2 |
|---|---|---|
| Parameter | 3GPP TS 38.101-2 | 3GPP TS 38.106 |
| TX Maximum Output | EIRP: 55 dBm, TRP: 35 dBm | No upper limit |
| Power | (Class1, FWA UE) | |
| TX Transmit Off Power | TRP : −35 dBm/MBW(−61 dBm/ | TRP: −36 dBm/MHz |
| | MHz, MBW = 400 MHz) | |
| TX ON/OFF Time Mask | Transient Period Length ≤5 us | Transient Period Length ≤3 μs |
| Frequency Error | ±0.1 ppm in 1 ms | ±0.01 PPM (The frequency deviation |
| | | of the output signal with respect to the |
| | | input signal) |
| TX Error Vector | QPSK <17.5% | 16QAM <12.5% |
| Magnitude | 16QAM <12.5% | 64QAM <8% |
| | 64QAM <8% | |
| TX ACLR | 17 dB | 28 dB |
| TX Spurious Emission | OOB Boundary = 2*CBW | [Category B] |
| | −36 dBm/100 KHz @ | −36 dBm/100 KHz @ |
| | (30 MHz, 1000 MHz) | (30 MHz, 1000 MHz) |
| | −30 dBm/1 MHz @ | −30 dBm/1 MHz @ |
| | (1 GHz, 12.75 GHz) | (1 GHz, 18 GHz) |
| | −30 dBm/1 MHz @ | |
| | (12.75 GHz ≤ f ≤ 2^{nd} | |
| | harmonic of the upper frequency edge | |
| | of the UL operating band in GHz | |
| RX Reference Sensitivity | EIS = −88.5 dBm/400 MHz | No |
| Power | | |

Transient Period Length: for the repeater, the part different than the CPE is the service antenna module (in contrast, the CPE is an SoC, or a baseband processor). Since the transient period length of the service antenna module (S-MAM) is mainly determined by the RF switches (which is less than 1 μs according to the current industry level), 3 μs is acceptable.

Frequency Error: ±0.01 PPM is not “frequency error,” but “frequency deviation.” The requirement could be met by the same clock reference between the donor antenna module (M-MAM) and the service antenna module (S-MAM), as shown in FIG. 3.

ACLR: due to a much greater bandwidth at the Mmw front end, there is no DPD for the CPE, the repeater, or the BS. ACLR is mainly determined by the linearity of front-end amplifiers. This requirement could be met by the first priority of the M-MAM/S-MAM.

Next, interface feasibility between a donor antenna module (M-MAM) and a service antenna module (S-MAM). The interface may include an Intermediate Frequency (IF) interface, and other possible interface.

IF interface: the interface between the donor antenna module and the service antenna module is IF cables and RFC cables (RFC signals can be combined with IF signals for simple transmission). The IF works about 4 GHz, at which the cable insertion loss may be less than 5 dB if the cable length is less than 10 m. The insertion loss value could be put in a Graphical User Interface (GUI) of the CPE, so that the loss can be compensated by the AGC of the S-MAN. RFC signals typically operate at a frequency below 1 GHz (e.g. MIPI interface). Accordingly, the cable loss of the RFC between the donor antenna module and the service antenna module.

Other possible interface: if a digital RF (in Serdes protocol) interface is selected to connect the M-MAM and the S-MAM, the SERDES speed could be higher than 10 Gbps, and the lane number could be greater than 5; a high speed passive multiplexer/demultiplexer should also be taken into careful consideration; the pass loss and the signal integrity between the M-MAM and the S-MAM could not be accepted, and a high speed digital repeater is therefore probably required.

Meanwhile, the IF interface has the following advantages: a low path loss at an intermediate frequency is incurred, and pass loss could be compensated by the AGC of the M-MAM/S-MAM; and the lane number is only 2 (horizontally (H) and vertically (V). Therefore, the IF interface is the best way to connect the donor antenna module and the service antenna module.

For ease of understanding, a list of full names of the abbreviations used herein is provided below:
ABF: Analog Beamforming
ADC: Analog to Digital Converter
AGC: Auto Gain Control
ACS: Auto Configuration Server
BB: Baseband
BF: Beamforming
BS: Base Station
CP: Customer Premise Equipment
CWMP: CPE WAN (Wide Access Network) Management Protocol
DL: Downlink
DoA: Direction of Arrival
DPD: Digital Pre-Distortion
DPDT: Double Pole Double Throw
DU: Donor Unit
FTTH: Fiber to the Home
FWA: Fixed Wireless Access
GP: Guard Period
GUI: Graphical User Interface
IF: Intermediate Frequency
MIPI: Mobile Industry Processor Interface
M-MAM: Master Mmw Antenna Module
OAM: Operation, Administration, and Maintenance
RF: Radio Frequency
RFC: Radio Frequency Control
RFIC: Radio Frequency Integrated Circuit
POE: Power on Ethernet
RSSI: Receive Signal Strength Indicate
RX: Receiver
SCS: Sub-carrier Space
SINR: Signal Interference Noise Ratio
SNR: Signal Noise Ratio
S-MAM: Slave Mmw Antenna Module
SPDT: Single Pole Double Throw
SU: Service Unit
TDD: Time Division Duplex
TRX: Transceiver
TX: Transmitter
UE: User Equipment
UL: Uplink

1. A communication device, comprising:
a donor antenna module for transmitting/receiving a radio frequency signal to/from a base station;
a service antenna module for transmitting/receiving a radio frequency signal to/from a terminal;
a System on Chip (SoC);
an intermediate frequency transceiver coupled to the SoC; and
a combiner comprising a combining port, a first branching port, and a second branching port,
wherein the combing port is coupled to the donor antenna module via an intermediate frequency combining channel, the first branching port is coupled to the intermediate frequency transceiver via a first intermediate frequency branching channel, and the second branching port is coupled to the service antenna module via a second intermediate frequency branching channel.

2. The communication device of claim 1, wherein a first link passing through the donor antenna module, the combiner, the intermediate frequency transceiver and the SoC forms a link for a Customer Premise Equipment (CPE), and a second link passing through the donor antenna module, the combiner and the service antenna module forms a link for a repeater.

3. The communication device of claim 2, wherein the donor antenna module has a hardware identifier for the CPE, and the service antenna module has a hardware identifier for the repeater.

4. The communication device of claim 1, wherein the communication device is configured to operate in a Time Division Duplex (TDD) mode, and the donor antenna module and the service antenna module each comprise a radio frequency switch for the TDD mode.

5. The communication device of claim 4, wherein, within a downlink period of the TDD mode, a first downlink signal from the first branching port to the intermediate frequency transceiver is identical to a second downlink signal from the second branching port to the service antenna module.

6. The communication device of claim 4, wherein switching of the donor antenna module from receiving to transmitting and switching of the service antenna module from transmitting to receiving occur in a special time slot of the TDD mode, and the special time slot follows a downlink time slot and precedes an uplink time slot.

7. The communication device of claim 6, wherein, in the special time slot, transmitting of the donor antenna module occurs after transmitting of the service antenna module has ended, and receiving of the service antenna module occurs after transmitting of the donor antenna module has ended.

8. The communication device of claim 1, wherein the SoC comprises a radio frequency control module configured to control the donor antenna module and the service antenna module using a radio frequency control signal.

9. The communication device of claim 1, further comprising:
a directional coupler located in the second intermediate frequency branching channel, an output port of the directional coupler being coupled to the intermediate frequency transceiver via a third link.

10. The communication device of claim 9, wherein the service antenna module is configured to provide a monitoring signal to the intermediate frequency transceiver via the directional coupler, the monitoring signal comprising a measurement signal for beamforming estimation from the terminal.

11. The communication device of claim 10, wherein the service antenna module is configured to transmit a reference signal for beamforming estimation in a special time slot of a TDD mode, and receive the measurement signal from the terminal in the special time slot.

12. The communication device of claim 9, wherein the intermediate frequency transceiver comprises a switch for switching to the third link to receive the monitoring signal.

13. The communication device of claim 9, wherein the SoC further comprises: a baseband processing module, a beam management module for the service antenna module, and a switch for switching between the baseband processing module and the beam management module.

14. The communication device of claim 1, wherein the SoC comprises an Operation, Administration, and Maintenance (OAM) management module configured to transmit and receive an OAM message for a CPE and a repeater.

15. The communication device of claim 14, wherein the SoC is configured to:
encapsulate the OAM message of the repeater in a CPE Wide Access Network (WAN) Management Protocol (CWMP) format; and
transmit the OAM message in the CWMP format to an Auto Configuration Server (ACS), for decapsulation at the ACS and transmission to a network center.

16. The communication device of claim 1, further comprising a motor for controlling rotation of the service antenna module.
